(19) United States
(12) Patent Application Publication
(10) Pub. No.: US 2003/0152394 A1
(43) Pub. Date: Aug. 14, 2003

(54) Developing device

(75) Inventors: Takahiro Nakase, Ibaraki (JP); Ryuji Kawano, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/327,179

(22) Filed: Dec. 24, 2002

(30) Foreign Application Priority Data
Dec. 27, 2001 (JP) 398374/2001(PAT.)

(51) Int. Cl. G03G 15/08

(52) U.S. Cl. 399/27; 399/258

(57) ABSTRACT

A developing device has a structure in which a toner is supplied from a toner supplying container to a first toner container by a toner supplying device and also the toner is conveyed from the first toner container to a second toner container by a toner conveying member disposed so as to lie in the space between the first and second toner containers. Thus, the developing device has a reduced size and also stably supplies the toner to two developing rollers corresponding to the first and second toner containers.

### BACKGROUND OF THE INVENTION

1. Field of the Invention

The present invention relates to a developing device, for example, used in a copying machine, a printer, or a facsimile machine of an electro-photographic type, an electronic recording type, or the like, for developing an electrostatic image formed on an image bearing member by supplying developers (toners) from first and second developer bearing members.

2. Description of the Related Art

In recent years, image forming apparatuses such as a copying machine and a printer have been required to output a printed image at increasingly higher speeds.

However, in a known developing device of the image forming apparatus, when a toner supplied from a toner container is held on the surface of one developing roller and an electrostatic latent image is developed (i.e., is visualized) by jumping (i.e., accreting) the toner on the latent image formed on a photoreceptor in an electrostatic manner, the toner held on the surface of the developing roller which is rotating at a high speed because of the speedup requirement quickly deteriorates.

In addition, the speedup causes the bored on the developing roller to jump on the photoreceptor and develop the latent image in a short period of time, thereby leading to a loss in image quality.

To solve the above-described problems, a developing device having a plurality of developing rollers for developing a latent image at each roller has been proposed. With this developing device, the deterioration of the toner and the loss in image quality of the high-speed image forming apparatus can be suppressed.

For example, as shown in FIG. 4, a developing device 101 has a structure in which a toner container 102 for containing a toner t has an opening opposing a photosensitive drum 100 where two developing rollers 103a and 103b are disposed. The surfaces of the developing rollers 103a and 103b are coated with thin films of the toner t by two regulating blades 104a and 104b.

In this developing device 101, the toner t is supplied from a toner supplying container 106 to the toner container 102 via a toner conveying device 107 on the basis of the data of a toner amount detected by a toner-amount detecting sensor 105.

Also, as shown in FIG. 5, the developing device 101 has another structure in which toner containers 102a and 102b have developing rollers 103a and 103b, respectively. In this developing device 101, the toner t is supplied from the toner supplying container 106 to the toner containers 102a and 102b via corresponding toner conveying devices 107a and 107b on the basis of the data of toner amounts detected by corresponding toner-amount detecting sensors 105a and 105b.

Although the known developing device 101 shown in FIG. 4 having only one toner container 102 and one toner conveying device 107 has a reduced size advantage, when the amount of the toner t in the toner container 102 varies in the range H shown in the figure, a supply amount of the toner t supplied to the developing roller 103a is different from that supplied to the developing roller 103b.

That is, as shown in FIG. 6, since a toner coating amount coated on the surface of the developing roller 103a disposed upstream with respect to the rotating direction of the photosensitive drum 100 varies depending on the amount of the toner t in the toner container 102, the toner coating amount decreases as a supply amount of the toner t supplied to the developing roller 103a decreases, resulting in a loss in image quality of an output image.

On the other hand, in the developing device 101 shown in FIG. 5, since supply amounts of the toner t supplied to the toner containers 102a and 102b are adjusted by the corresponding toner conveying devices 107a and 107b, stable amounts of the toner t are coated on the surfaces of the developing rollers 103a and 103b. However, since the toner conveying devices 107a and 107b are disposed for supplying the toner t to the corresponding toner containers 102a and 102b, a space for housing two toner conveying devices is required, thereby resulting in an increased size of the developing device 101.

In particular, since the image forming apparatus not only performing at a high speed but also having a reduced size has been required in recent years, a compact developing device having a plurality of developing rollers also has been desired.

### SUMMARY OF THE INVENTION

It is an object of the present invention to provide a developing device which has a reduced size and stably supplies a developer or a toner.

A developing device comprises a first developer container for containing a developer; a first developer bearing member for bearing and conveying the developer in the first developer container; a second developer container for containing a developer; and a second developer bearing member for bearing and conveying the developer in the second developer container. An electrostatic image formed on an image bearing member is developed by supplying the developers from the first and second developer bearing members to the electrostatic image. The developing device further comprises developer supplying means for supplying the developer in a developer supplying container to the first developer container; and developer conveying means for conveying the developer in the first developer container to the second developer container in order to supply the developer to the second developer container.

Further objects, features and advantages of the present invention will become apparent from the following description of the preferred embodiments with reference to the attached drawings.

### BRIEF DESCRIPTION OF THE DRAWINGS

FIG. 1 is a schematic view illustrating the main part of an image forming apparatus having a developing device according to a first embodiment of the present invention.

FIG. 2 is a schematic view illustrating the main part of the image forming apparatus having a developing device according to a second embodiment of the present invention.

FIGS. 3A and 3B illustrate conveying operations of a toner by a toner conveying member (a magnet roller) of the developing device according to the second embodiment of the present invention.

FIG. 4 is a schematic view of an example known developing device.

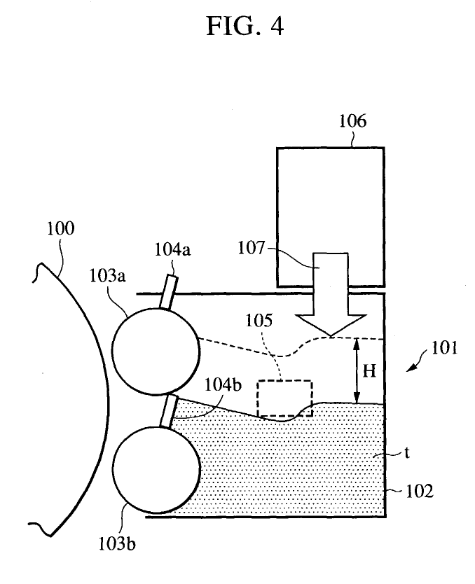

FIG. 5 is a schematic view of another example known developing device.

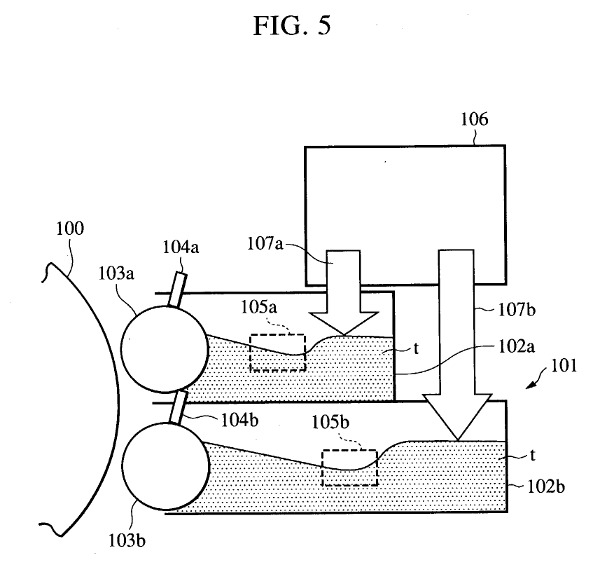

FIG. 6 is a graph illustrating the relationships between a toner amount in a container (a toner container) and a toner coating amount on a developing roller.

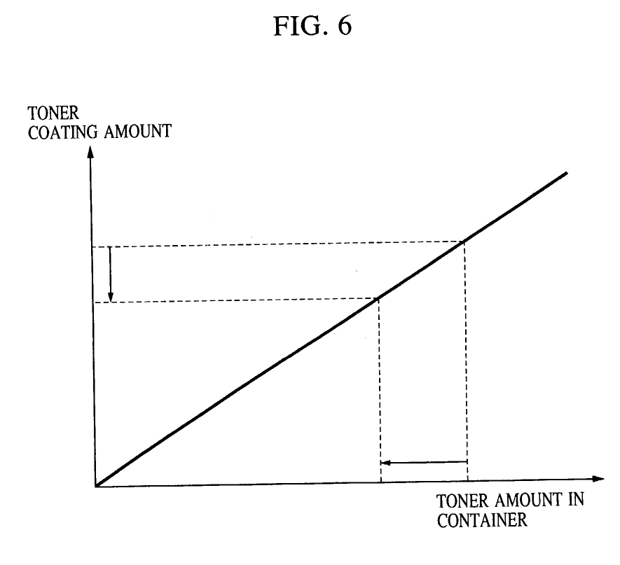

### DESCRIPTION OF THE PREFERRED EMBODIMENTS

Preferred embodiments of the present invention will be described with reference to the accompanying drawings.

### First Embodiment

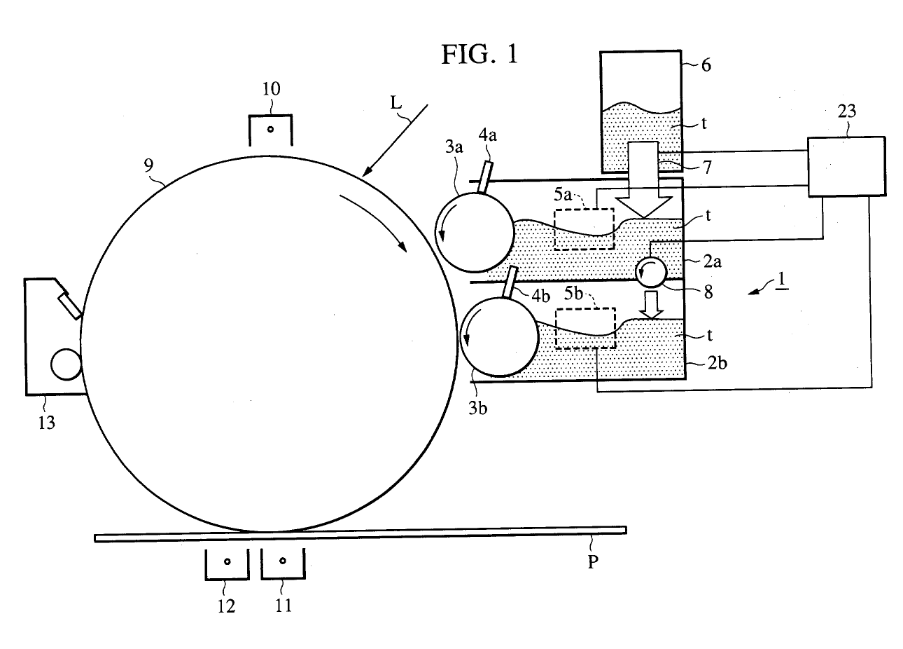

FIG. 1 is a schematic view illustrating the main part of an image forming apparatus having a developing device according to a first embodiment of the present invention.

The image forming apparatus has a developing device 1, a primary charger 10, a transfer charger 11, a detach charger 12, and a cleaner 13 around a drum-shaped electro-photographic photoreceptor (hereinafter, referred to as a photosensitive drum) 9 serving as a developer bearing member. When an image is being formed, an exposure device (not shown) sheds image exposing light L on the photosensitive drum 9 which is charged by the primary charger 10 and rotates in the direction by the arrow indicated in the figure (i.e., a clockwise direction) and an electrostatic latent image is formed in accordance with input image data. In this stage, two developing rollers 3a and 3b of the developing device 1, which will be described in detail later, are applied with a developing bias having the same polarity as the charged developing device 1, and a toner (developer) t is charged so as to have the same polarity as the charged developing device 1. Thus, the charged toner t is accreted to the electrostatic latent image by the two developing rollers 3a and 3b so that the latent image is visualized as a toner image (a developer image). The toner t may be a magnetic single-component developer, for example.

When the toner image formed on the photosensitive drum 9 exactly reaches a transfer nip between the photosensitive drum 9 and the transfer charger 11, a transfer material P such as a sheet of paper is fed to the transfer nip, and the toner image formed on the photosensitive drum 9 is transferred to the transfer material P by the transfer charger 11 applied with a transfer bias having the opposite polarity as the toner t by using an electrostatic force produced between the photosensitive drum 9 and the transfer charger 11.

The transfer material P having the transferred toner image thereon is detached from the photosensitive drum 9 by the detach charger 12 applied with a detach bias and is transferred to a fixing device (not shown). Then, the toner image is fixed to the transfer material P at a fixing nip between the fixing device and a pressure roller (not shown) by heating and pressuring and is output to the outside. The toner remaining on the photosensitive drum 9 after the above-described transfer is removed and collected by the cleaner 13.

Next, the structure of the developing device 1 according to the first embodiment will be described.

The developing device 1 according to the first embodiment has first and second toner containers 2a and 2b for containing the toner t; a toner supplying container 6; a toner supplying device 7 serving as toner supplying means for supplying and conveying the toner t in the toner supplying container 6 to the first toner container 2a; and the developing rollers 3a and 3b disposed in the openings of the first and second toner containers 2a and 2b, respectively, along the rotating direction of the photosensitive drum 9, so as to oppose the photosensitive drum 9 in the developing region of the developing device 1 and to serve as developer bearing members which are rotatable in the direction of the arrow indicated in the figure (i.e., a clockwise direction). As described above, the developing device 1 according to the first embodiment has the two first and second toner containers 2a and 2b which are formed independently from each other.

The first and second toner containers 2a and 2b respectively have regulating blades 4a and 4b, for coating the toner t on the developing rollers 3a and 3b, and toner-amount detecting sensors 5a and 5b for detecting toner amounts therein. Also, the first and second toner containers 2a and 2b have a communication opening therebetween and a toner conveying member 8, placed in the communication opening, for conveying and supplying the toner t in the first toner container 2a supplied from the toner supplying container 6 to the second toner container 2b. The toner conveying member 8 may be a magnet roller, for example, which will be described in the second embodiment.

The first toner container 2a is integrally disposed with and above the second toner container 2b and the communication opening is formed in a separation portion which separates these two toner containers 2a and 2b above and below, respectively. The toner supplying device 7 and the toner conveying member 8 may be formed by known conveying members.

Conveyance and supply of the toner t from the toner supplying container 6 to the first toner container 2a by the toner supplying device 7 and those from the first toner container 2a to the second toner container 2b by the toner conveying member 8 are controlled by a controller 23 on the basis of detection data received from the toner amount detecting sensors 5a and 5b, respectively.

The conveyances of the toner t to the first and second toner containers 2a and 2b in the developing device 1 according to the first embodiment will be described below.

When the toner-amount detecting sensor 5a detects that the toner t in the first toner container 2a decreases as the developing device 1 operates, the controller 23 causes the toner supplying device 7 to operate on the basis of the received detection data so as to convey the toner t from the toner supplying container 6 to the first toner container 2a. The toner t in the first toner container 2a is supplied to the developing roller 3a by an agitating and conveying member (not shown) and used for developing an electrostatic image formed on the photosensitive drum 9.

Also, when the toner-amount detecting sensor 5b detects that the toner t in the second toner container 2b decreases as the developing device 1 operates, the controller 23 causes the toner conveying member 8 to operate on the basis of the received detection data so as to convey the toner t from the first toner container 2a to the second toner container 2b. The toner t in the second toner container 2b is supplied to the developing roller 3b by another agitating and conveying member (not shown) and used for developing an electrostatic image formed on the photosensitive drum 9.

In the first embodiment, in the case in which the toner t is supplied from the toner supplying container 6 to the first toner container 2a by the toner supplying device 7 and is also conveyed from the first toner container 2a to the second toner container 2b, when a conveyance (supply) amount of the toner t per unit of time from the toner supplying container 6 to the first toner container 2a by the toner supplying device 7 is defined as A, the maximum necessary amount of the toner t per unit of time conveyed onto the developing roller 3a for developing is defined as B, and the maximum necessary amount of the toner t per unit of time conveyed onto the developing roller 3b for developing is defined as C, these three amounts are controlled by the controller 23 so as to satisfy the following formula:

A≧B+C (1).

By controlling these amounts as described above, even when the toner-amount detecting sensors 5a and 5b detect shortages of the toner t in the corresponding first and second toner containers 2a and 2b substantially at the same time, the toner t is sufficiently supplied to both developing rollers 3a and 3b.

As described above, according to the first embodiment, by using the single common toner supplying container 6, the toner t is effectively conveyed to both first and second toner containers 2a and 2b and is thus stably and sufficiently supplied to both developing rollers 3a and 3b. In addition, the toner conveying member 8 placed between the first and second toner containers 2a and 2b conveys the toner t to the second toner container 2b, thereby leading to a reduced size of the developing device 1 and also to a stable supply of the toner t to both developing rollers 3a and 3b.

### Second Embodiment

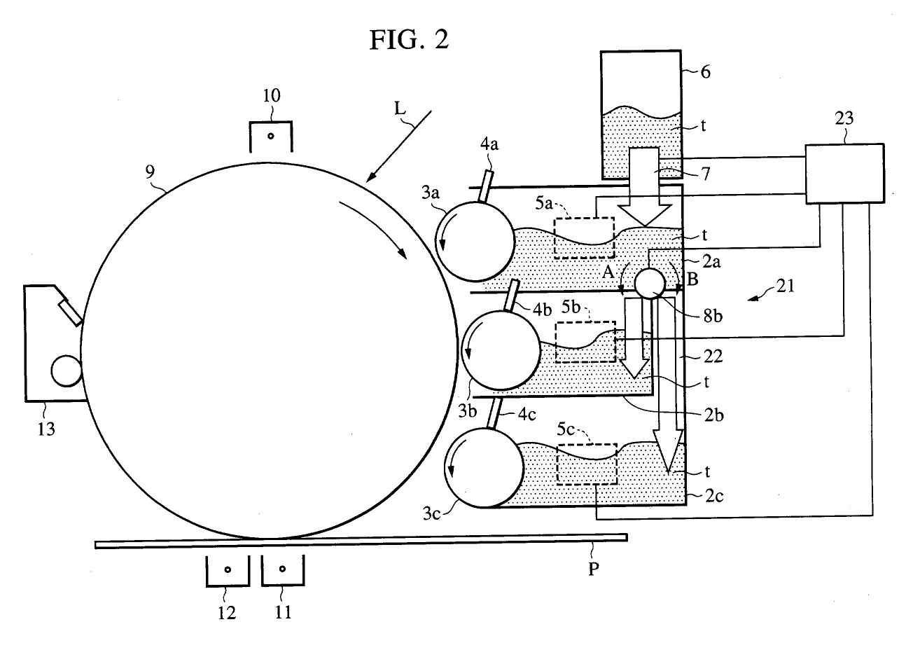

FIG. 2 is a schematic view illustrating the main part of the image forming apparatus having a developing device according to a second embodiment of the present invention. Like parts are identified by the same reference numerals and symbols in the first embodiment and a repeated description thereof is omitted. In the second embodiment, only the developing device will be described since the image forming apparatus has the same structure as that in the first embodiment except for the developing device.

As shown in FIG. 2, a developing device 21 according to the second embodiment has the first and second toner containers 2a and 2b and a third toner container 2c for containing the toner t; the toner supplying device 7; the toner supplying container 6 for conveying (supplying) the toner t to the first toner container 2a via the toner supplying device 7; and the developing rollers 3a and 3b and a developing roller 3c disposed in the openings of the first to third toner containers 2a to 2c, respectively, so as to serve as developer bearing members which oppose the photosensitive drum 9 in the developing region of the developing device 21 and which are rotatable in the direction of the arrow indicated in the figure (i.e., a counterclockwise direction). As described above, the developing device 21 according to the second embodiment has the three first to third toner containers 2a to 2c which are formed independently from each other.

The first to third toner containers 2a to 2c respectively have the regulating blades 4a and 4b and a regulating blade 4c for coating the toner t on the developing rollers 3a to 3c, in addition to having the toner-amount detecting sensors 5a and 5b and a toner-amount detecting sensors 5c for detecting toner amounts therein.

The first to third toner containers 2a to 2c are integrally disposed in the vertical direction. Also, the developing device 21 has a toner conveying member 8b and a conveying passage 22, for conveying (supplying) the toner t in the first toner container 2a to the third toner container 2c via the toner conveying member 8b, in the space between the wall of the second toner container 2b lying opposite to the developing roller 3b and the upper surface of the third toner container 2c.

The toner conveying member 8b is disposed under the first toner container 2a so as to lie in the space formed by upper surface of the second toner container 2b and the conveying passage 22 above the third toner container 2c. The toner conveying member 8b in the second embodiment is the foregoing magnet roller which is disposed in the longitudinal direction of developing roller 3a and whose rotating direction is controllable. When the toner conveying member (magnet roller) 8b is controlled to rotate in the direction of the arrow A indicated in the figure (a counterclockwise direction), the toner t is conveyed to the second toner container 2b, and when the toner conveying member (magnet roller) 8b is controlled to rotate in the direction of the arrow B indicated in the figure (a clockwise direction), the toner t is conveyed to the third toner container 2c via the conveying passage 22.

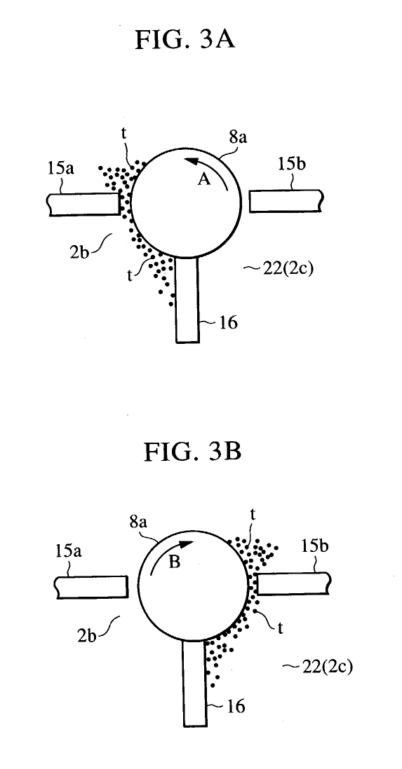

The structure of the magnet roller serving as a toner conveying member 8a will be described in detail. When the toner t in the first toner container 2a is to be conveyed to the second toner container 2b, as shown in FIG. 3A, the toner t in the toner supplying container 6 is attracted by the magnetic force of the magnet roller (toner conveying member) 8a onto the surface of the magnet roller (toner conveying member) 8a, and, while rotating the magnet roller (toner conveying member) 8a in the direction of the arrow A indicated in the figure (i.e., a counterclockwise direction), the amount of the toner t held on the surface of the magnet roller (toner conveying member) 8a is regulated by a toner regulating plate 15a having a predetermined gap from the surface of the magnet roller. Then, the toner t is scraped off the surface of the magnet roller (toner conveying member) 8a bearing a certain amount of the toner t thereon by a toner scraping plate 16 abutting against the magnet roller (toner conveying member) 8a so that the scraped toner t drops into the second toner container 2b. With this arrangement, the toner t is conveyed from the toner supplying container 6 to the second toner container 2b via the first toner container 2a.

When the toner t in the first toner container 2a is to be conveyed to the third toner container 2c, as shown in FIG. 3B, the toner t in the toner supplying container 6 is attracted by the magnetic force of the magnet roller (toner conveying member) 8a onto the surface of the magnet roller (toner conveying member) 8a, and, while rotating the magnet roller (toner conveying member) 8a in the direction of the arrow B indicated in the figure (i.e., a clockwise direction), the amount of the toner t held on the surface of the magnet roller (toner conveying member) 8a is regulated by a toner regulating plate 15b having a predetermined gap from the surface of the magnet roller. Then, the toner t is scraped off the surface of the magnet roller (toner conveying member) 8a bearing a certain amount of the toner t thereon by the toner scraping plate 16 abutting against the magnet roller (toner conveying member) 8a so that the scraped toner t drops into the third toner container 2c via the conveying passage 22. With this arrangement, the toner t is conveyed from the toner supplying container 6 to the third toner container 2c via the first toner container 2a.

Conveyance and supply of the toner t from the toner supplying container 6 to the first toner container 2a by the toner supplying device 7 and those from the first toner container 2a to the second or third toner container 2b or 2c by rotation of the toner conveying member (magnet roller) 8b are controlled by the controller 23 on the basis of detection data received from the toner-amount detecting sensors 5a or 5c, respectively.

The conveyances of the toner t to the first to third toner containers 2a to 2c of the developing device 21 according to the second embodiment will be described below.

When the toner-amount detecting sensor 5a detects that the toner t in the uppermost first toner container 2a decreases as the developing device 21 operates, the controller 23 causes the toner supplying device 7 to operate on the basis of the received detection data so as to convey the toner t from the toner supplying container 6 to the first toner container 2a. The toner t in the first toner container 2a is supplied to the developing roller 3a by an agitating and conveying member (not shown) and used for developing an electrostatic image formed on the photosensitive drum 9.

Also, when the toner-amount detecting sensor 5b detects that the toner t in the second toner container 2b lying between the first and third toner containers 2a and 2c decreases as the developing device 21 operates, the controller 23 causes the toner conveying-member (magnet roller) 8b to rotate in the direction of the arrow A indicated in the figure (i.e., a counterclockwise direction) on the basis of the received detection data so as to convey the toner t from the first toner container 2a to the second toner container 2b. The toner t in the second toner container 2b is supplied to the developing roller 3b by another agitating and conveying member (not shown) and used for developing an electrostatic image formed on the photosensitive drum 9.

In addition, when the toner-amount detecting sensor 5c detects that the toner t in the lowermost third toner container 2c decreases as the developing device 21 operates, the controller 23 causes the toner conveying member (magnet roller) 8b to rotate in the direction of the arrow B indicated in the figure (i.e., a clockwise direction) on the basis of the received detection data so as to convey the toner t from the first toner container 2a to the third toner container 2c via the conveying passage 22. The toner t in the third toner container 2c is supplied to the developing roller 3c by another agitating and conveying member (not shown) and used for developing an electrostatic image formed on the photosensitive drum 9.

In the second embodiment, in the case in which the toner t is supplied from the toner supplying container 6 to the first toner container 2a by the toner supplying device 7 and is also conveyed from the first toner container 2a to the second or third toner container 2b or 2c by rotation of the toner conveying member (magnet roller) 8b, when a conveyance (supply) amount of the toner t per unit of time from the toner supplying container 6 to the first toner container 2a by the toner supplying device 7 is defined as A, the maximum necessary amount of the toner t per unit of time conveyed onto the developing roller 3a for developing is defined as B, the maximum necessary amount of the toner t per unit of time conveyed onto the developing roller 3b for developing is defined as C, the maximum necessary amount of the toner t per unit of time conveyed onto the developing roller 3c for developing is defined as D, and a conveyance (supply) amount of the toner t per unit of time conveyed by rotation of the toner conveying member (magnet roller) 8b is defined as E, these amounts are controlled by the controller 23 so as to satisfy the following formulas (2) and (3):

A≧B+C+D (2), and

E≧(C or D)×2 (3).

By controlling these amounts as described above, even when the toner-amount detecting sensors 5a to 5c detect shortages of the toner t in the corresponding first to third toner containers 2a to 2c substantially at the same time, the toner t is sufficiently supplied not only to the developing roller 3a but also to the developing rollers 3b and 3c by switching the rotating direction of the toner conveying member (magnet roller) 8b as required.

As described above, according to the second embodiment, the toner t is effectively conveyed to the first to third toner containers 2a to 2c and is thus stably and sufficiently supplied to the developing rollers 3a to 3c. In addition, the toner conveying member (magnet roller) 8b disposed so as to lie in the space formed the upper surface of the second toner container 2b and the conveying passage 22 disposed above the third toner container 2c conveys the toner t to the second and third toner containers 2b and 2c, thereby leading to a reduced size of the developing device 21 and also to a stable supply of the toner t to the developing rollers 3a to 3c.

According to the above-described embodiments, a developing device which has a reduced size and also stably supplies toner to first and second toner containers can be achieved.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A developing device comprising:
a first developer container for containing a developer;
a first developer bearing member for bearing and conveying the developer in said first developer container;
a second developer container for containing a developer;
a second developer bearing member for bearing and conveying the developer in said second developer container;
wherein an electrostatic image formed on an image bearing member is developed by supplying the developers from said first and second developer bearing members to the electrostatic image;
developer supplying means for supplying the developer in a developer supplying container to said first developer container; and
developer conveying means for conveying the developer in said first developer container to said second developer container in order to supply the developer to said second developer container.

2. The developing device according to claim 1, wherein said developer conveying means is disposed in a communicating portion between said first and second developer containers and comprises a rotating member for conveying the developer from said first developer container to said second developer container.

3. The developing device according to claim 2, wherein the developer is a magnetic developer and is magnetically bored and conveyed by said rotating member.

4. The developing device according to claim 3, wherein said first and second developer containers are integrally disposed with each other and the communicating portion is an opening disposed in a separation portion which separates said first and second developer containers from each other.

5. The developing device according to any one of claims 1 to 4, further comprising:
detecting means for detecting respective amounts of the developer in said first and second developer containers; and
controlling means for controlling operations of said developer supplying means and said developer conveying means on the basis of output from said detecting means.

6. The developing device according to claim 1, further comprising:
a third developer container for containing a developer; and
a third developer bearing member for bearing and conveying the developer in said third developer container,
wherein said developer conveying means comprises a single rotating member for selectively conveying the developer in said first developer container to either one of said second and third developer containers.

7. The developing device according to claim 6, wherein the developer is selectively conveyed to either one of said second and third developer containers by switching the rotating direction of said rotating member.

8. The developing device according to claim 7, wherein said second and third developer containers have respective developer-receiving openings thereupon for receiving the developer from said first developer container and said rotating member is disposed in these developer-receiving openings.
